(19) United States
(12) Patent Application Publication
(10) Pub. No.: US 2012/0153057 A1
(43) Pub. Date: Jun. 21, 2012

(54) DEVICE FOR LOCKING THE CHOCK AND THE AXIAL BEARING HOUSING OF A ROLL SET AND THE ROLL-CHANGING CARRIAGE

(76) Inventors: Konrad Schunn, Korshenbroich (DE); Lothar Zwingmann, Haan (DE); Holger Pulst, Mettmann (DE); Arnulf Wurm, Olpc (DE); Ruedier Holz, Neunkirchen (DE)

(21) Appl. No.: 13/379,424

(22) PCT Filed: Jul. 7, 2010
(86) PCT No.: PCT/EP10/04085

§ 371 Date: Mar. 8, 2012

(30) Foreign Application Priority Data
Jul. 7, 2009 (DE) 102009032200.0
Dec. 28, 2009 (DE) 102009060641.6

(51) Int. Cl. A01F 21/00

(52) U.S. Cl. 241/37.5

(57) ABSTRACT

The invention relates to a device for locking the chock (3) and the axial bearing housing (5) of a roll set as well as the roll change carriage (7) during rolling and during change of rolls. In that case provided at the roll housing (1) is a horizontally displaceable locking device (2) having locking elements (4, 6, 9) by way of which the locking device (2) for axial displacement of the roll is lockable to the roll chock (3) in order to fix the position of the axial bearing housing (5) with respect to the chock (3) of the roll or is lockable to the roll change carriage in the roll change position.

The invention relates to a device for locking the chock and the axial bearing housing of a roll set as well as the roll change carriage during rolling and during change of rolls.

Wear of the rolls of a roll stand or a program change obliges change of the roll sets in the individual roll stands of a rolling mill.

For this purpose, use is made in practice of a roll change carriage by which the roll sets can be moved into the roll stand or moved out of this.

In known constructions the roll change carriage is locked in position at the roll stand by an own locking bar provided for that purpose. Equally, it is known that the locking bars, which are mounted at the operating side, for locking the chocks in the stand are combined with the axial displacement of the working rolls (4-roll roll stand) or intermediate rolls (18 HS roll stand).

In the case of a roll change, the axial bearing is not fixedly connected with the chock during the roll change. This has the consequence that during movement of rolls into and out of the stand by means of the roll change carriage, which pushes or draws the roll set against the axial bearing housing, the position of the chocks relative to the axial bearing housing changes, which leads to difficulties during locking in the roll stand, or the position of the roll set on the carriage does not correspond with that desired.

The object of the invention is to avoid the afore-described disadvantages.

According to the invention this object is fulfilled, in the case of a device for locking the chock and the axial bearing housing of a roll set as well as the roll change carriage during rolling and during change of rolls, in that provided at the roll housing is a vertically and horizontally displaceable locking device having locking elements by way of which the locking device for axial displacement of the roll is lockable to the roll chock in order to fix the position of the axial bearing housing with respect to the chock of the roll or is lockable to the roll change carriage in the roll change position.

Preferred embodiments are evident from the subclaims and are described in the following.

The new locking concept combines the two functions so that the combined axial displacement/locking makes possible—apart from locking the working roll chocks in a 4-roll roll stand or locking of the intermediate roll chocks in an 18 HS roll stand and the axial displacement of the rolls in the chocks—additionally also locking of the roll change carriage in the change position at the roll stand without a separate function being required for that purpose.

The new concept further provides, for the case of a roll change, locking of the axial bearing, by means of a pivotable latch, to the chock. It is thereby achieved that during the roll change the roll set itself does not change and a faultless locking in the stand or a correct positioning on the roll change carriage is possible.

The invention shall now be explained in more detail in the following with reference to the drawings, in which:

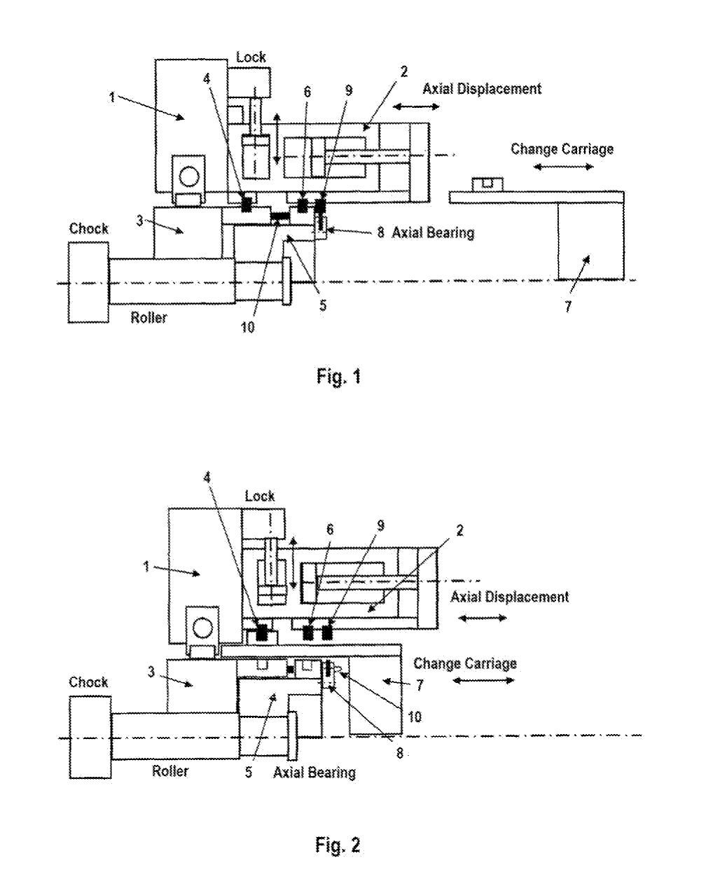

FIG. 1 shows an illustration of the locking at the chock/axial bearing housing,

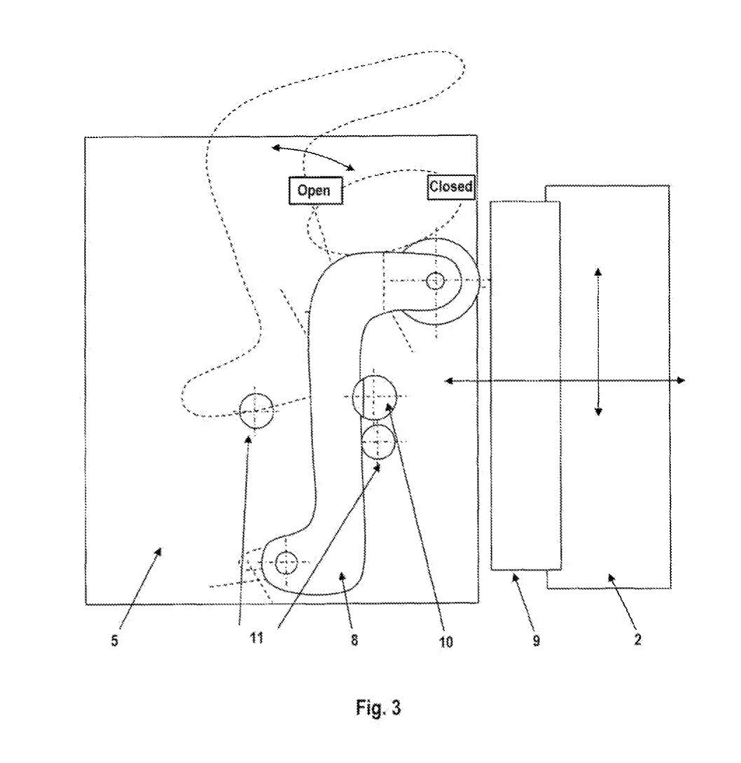

FIG. 2 shows an illustration of the locking at the roll change carriage and

FIG. 3 shows an illustration of the latch for locking the chock to the axial bearing housing.

In FIG. 1 the situation can be seen in which the roll is inserted in the roll stand. The combined locking/axial displacing means 2 guided at the roll housing locks the chock 3 of the roll set by the locking element 4 as well as the axial bearing housing 5 of the roll set by the locking element 6.

In FIG. 2 the situation can be seen in which a roll change is taking place. Not only the chock 3, but also the axial bearing housing 5 are unlocked. The combined locking/axial displacing means 2 guided at the roll housing 1 locks the roll change carriage 7 by the locking element 4.

The new concept incorporates a device for locking the chock 3 to the axial bearing housing 5 by means of a pivotable latch 8, which can be opened by a locking element 9 mounted at the block of the combined locking/axial displacing means 2 and which on movement away of the locking element 9 axially locks, by its own weight, the chock 3 to the axial bearing housing 5 by way of an axially arranged pin 10, which is fixedly mounted at the chock 3 and which is led through the axial bearing housing 5. The pin 10 is chamfered at the end so that on movement together of the roll set the pivotable latch 8 can be pressed away at the chamfer and then, on complete movement together of the roll set, drops by it own weight into the groove provided in the pin 10. In order to avoid tipping away of the pivotable latch 8 in the free state, two abutments 11 are fastened to the axial bearing housing 5.

1. A device for locking the chock and the axial bearing housing of a roll set as well as the roll change carriage during rolling and during change of rolls, wherein provided at the roll housing is a horizontally displaceable locking device having locking elements by way of which the locking device for axial displacement of the roll is lockable to the roll chock in order to fix the position of the axial bearing housing with respect to the chock of the roll or is lockable to the roll change carriage in the roll change position.

2. The device according to claim 1, wherein provided at the chock is a pin which is arranged to be axially fixed and which is led through the axial bearing housing and that provided at the axial bearing housing is a pivotable latch which can be brought into engagement with the pin, which protrudes out of the axial bearing housing, in such a manner that the axial spacing between the chock and the axial bearing housing during the roll change is fixable by way of this pin.

3. The device according to claim 2, wherein the pivotable latch can be brought into engagement by means of one locking element for unlocking.

4. The device according to any claim 1, wherein the pivotable latch can, on movement away of the locking element, be brought by its own weight into engagement with the pin so as to axially lock the chock relative to the axial bearing housing.

5. The device according to claim 1, wherein the pin is chamfered at the end, which protrudes out of the axial bearing housing, so that on movement together of the roll set the pivotable latch can be pressed away at the chamfer and can be brought by its own weight into engagement with the pin.

6. The device according to claim 1, wherein two abutments are provided at the axial bearing housing for avoidance of tipping away of the pivotable latch in the free state.
